(19) United States
(12) Patent Application Publication
(10) Pub. No.: US 2016/0197837 A1
(43) Pub. Date: Jul. 7, 2016

(54) Method for Conveying Media to a Cloud Computing Environment

(71) Applicant: L&M IP, Huntsville, AL (US)

(72) Inventors: Larry W. Fullerton, New Hope, AL (US); Mark D. Roberts, Huntsville, AL (US); Dennis M. Weldy, Madison, AL (US); Eric Fullerton, Huntsville, AL (US)

(73) Assignee: L&M IP, Huntsville, AL (US)

(21) Appl. No.: 14/988,568

(22) Filed: Jan. 5, 2016

Related U.S. Application Data
(60) Provisional application No. 62/099,937, filed on Jan. 5, 2015.

(51) Int. Cl. H04L 12/841; H04L 29/08

(52) U.S. Cl. CPC H04L 47/283; H04L 67/10

(57) ABSTRACT

An improved method for conveying media to a cloud computing environment involves a media recording device interfaced with a cloud computing environment that conveys a recorded media to the cloud computing environment, where the conveying of the media to the cloud may be based upon the occurrence of a user-defined event and/or a user command. Data latency rules can be established to control whether various optional functions pertaining to processing of a recorded media are performed or not or an amount or rate corresponding to a processing function being performed depending on a user-defined condition or sensed event. Data latency rules may be based on one or more established data latency thresholds. A user may establish a set of parameters relating to which media data processing functions are to be used or not used and the extent to which they may be used so as to control data latency while meeting certain user requirements, where media data processing functions are either turned on or off or an extent changed based on criteria or rules established by a user.

### FIELD OF THE INVENTION

The present invention relates generally to a method for conveying media to a cloud computing environment (i.e., ‘the cloud’). More particularly, the present invention relates to a method for conveying media to the cloud based on the occurrence of a user-defined event.

### SUMMARY OF THE INVENTION

Briefly, the present invention is an improved method for conveying media to a cloud computing environment involving enabling a user of a media recording device to establish a data latency rule, recording a media using the media recording device to produce media data, the media recording device controlling a data processing function pertaining to the media data in accordance with the data latency rule, and conveying the media data to a cloud computing environment.

The data latency rule may pertain to a data latency threshold.

The data latency rule may pertain to a user defined condition.

The data latency rule may pertain to a sensed condition.

Controlling a data processing function may control whether the processing function is performed, which may involve encrypting the media data, storing the media data on the media recording device, or including metadata with the media data.

Metadata may include one of an identity of the media author, a media title, a date of the media recording, a time of the media recording, or a location where the media was recorded.

Metadata may include a characteristic of the media recording device, which can be an orientation of the media recording device, a velocity of the media recording device, an acceleration of the media recording device, or a geolocation of the media recording device.

Metadata may include a characteristic of the physical environment in which the media recording device was located when the media was recorded, which can be a temperature, a barometric pressure, or a light level.

Metadata may include biometric data.

Controlling the data processing function may control an amount or rate corresponding to the data processing function.

The amount or rate may pertain to data sampling, data compression, data buffering, or data resolution.

The media recording device may be a mobile phone.

The media recording device may be located in a building.

The media recording device may be located on one of a person or an animal.

The media recording device may be associated with a vehicle.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts a user of a phone recording an event that is conveyed to the cloud;

FIG. 2A depicts a first exemplary method in accordance with the invention;

FIG. 2B depicts a second exemplary method in accordance with the invention;

FIG. 2C depicts a third exemplary method in accordance with the invention;

FIG. 2D depicts a fourth exemplary method in accordance with the invention;

FIG. 3A depicts a fifth exemplary method in accordance with the invention;

FIG. 3B depicts a sixth exemplary method in accordance with the invention;

FIG. 3C depicts a seventh exemplary method in accordance with the invention;

FIG. 3D depicts an eighth exemplary method in accordance with the invention;

FIG. 4A depicts a ninth exemplary method in accordance with the invention;

FIG. 4B depicts a tenth exemplary method in accordance with the invention;

FIG. 4C depicts an eleventh exemplary method in accordance with the invention;

FIG. 5A depicts a twelfth exemplary method in accordance with the invention;

FIG. 5B depicts a thirteenth exemplary method in accordance with the invention;

FIG. 5C depicts an fourteenth exemplary method in accordance with the invention;

FIG. 6 depicts a fifteenth exemplary method in accordance with the invention; and

FIG. 7 depicts an exemplary computing architecture in accordance with the invention.

### DETAILED DESCRIPTION OF THE INVENTION

In accordance with one aspect of the present invention, a media recording device interfaced with a cloud computing environment conveys a recorded media to the cloud computing environment in near real-time while the media is being recorded by the media recording device, where the conveying of the media to the cloud may be based upon the occurrence of a user-defined event and/or a user command, where the media may or may not be encrypted and storage of a local copy of the media is optional. The media recording device may also upload to the cloud a previously recorded media stored on the media recording device. The uploading of the previously recorded media may be in accordance with a schedule and/or upon the occurrence of a user-defined event, where the media may be encrypted when stored on the media recording device and subsequently uploaded to the cloud or stored on the media recording device as unencrypted data that is then encrypted as it is uploaded to the cloud or after it has been uploaded to the cloud (i.e., by a cloud service provider as opposed to encryption by the media recording device). Rules may be established and enforced for forbidding access, modification and/or erasure from the recording device and/or the cloud.

Under one arrangement a first recording device forwards a media to a second recording device that conveys the media to the cloud, where the first recording device could be a service interfacing with multiple second recording devices and which could be configured to have substantial network bandwidth significantly greater than that required and typically used by the individual second recording devices.

In accordance with another aspect of the invention, data latency rules can be established to control whether various optional functions pertaining to processing of a recorded media (e.g., encryption, local storage, adding of metadata, etc.) are performed or not or an amount or rate corresponding to a processing function being performed (e.g., data compression level, data sampling rate, data buffering amount, resolution, etc.) for a given recorded media. Data latency rules may be based on one or more established data latency thresholds corresponding to one or more user-defined conditions. For example, a data compression rate and/or data sampling rate may be controlled in real-time as required to keep data latency below an established data latency threshold. Moreover, a data latency threshold may be conditional in that it might be modified or overridden, for example, based on an event such as a sensed event. For example, given a sensed fire condition, all unnecessary processing may be avoided regardless of an established data latency threshold.

Under one arrangement, a user may establish a set of parameters relating to which media data processing functions are to be used or not used and the extent to which they may be used (e.g., sampling rate, amount of data compression, data resolution) so as to control data latency while meeting certain user requirements (e.g., user always wants encryption), where media data processing functions are either turned on or off or an extent (e.g., rate, resolution) changed based on criteria or rules established by a user. Such criteria may determine a sampling rate, an amount of data compression, the extent of which metadata is added. For example, a user may establish a parameter where video is to be captured at a 1080i (i.e., 1920×1080) resolution but, when a certain criteria is met, the resolution is to change to a different resolution, which may be, for example, a lower resolution (e.g., 702p) or higher resolution (8640p).

Under another arrangement a command may be provided by the user of a media recording device to change a mode of operation. For example, an “upload button” might be pressed or an upload voice command may be spoken to cause an upload to the cloud function to be started immediately. Similarly, a “fast upload button” might be pressed or a fast upload function otherwise initiated to cause an upload function to be initiated under conditions that provide for minimal data latency. Generally, a user may establish one or more events that correspond to ‘fast load triggers’, whereby the occurrence of such an event causes the fast upload function to be initiated.

In accordance with one feature of the invention, a data latency indicator may be provided which might be a number and/or a color or some other indicator.

In accordance with another feature of the invention, an event may result in other applications running on a device (e.g., cell phone) being turned off in order to speed up performance of the device or otherwise reduce data latency.

In accordance with yet another aspect of the invention, access controls can be employed to prevent unauthorized access to or deletion of a recorded media stored on the media recording device and/or on the cloud. One or more deletion events can also be defined by a user, where a local copy of recorded media will be automatically deleted from the media recording device based on the occurrence of a deletion event.

A media recording device can include a video recording device and/or an audio recording device, for example, a camera and a microphone of a mobile phone or a Bluetooth or Wi-Fi connected device, and the media can be, for example, video (still picture or movie) and/or audio data recorded by the video and audio recording devices of the phone, where the recorded media is in the form of digital data. Other examples of media recording devices include a media recording device located in a home or business, a media recording device (e.g., dash cam) located in a vehicle (e.g., car, truck, emergency vehicle, plane, helicopter, drone, etc.), a media recording device (e.g., body cam) associated with a person or animal, or a media recording devices associated with a fixed object (e.g., bridge, tree, light post, gas pump, etc.). Recorded media may be in the form of text, for example, where an audio recording device converts voice to text. Video data may correspond to a picture or video taken from the front (display side) of a cell phone or from the back of a cell phone, or both, which may be taken simultaneously. As such, an event being filmed may be captured at the same time the user of a media recording device is captured (e.g., a selfie).

Encryption of media data, whether stored on the media recording device or on the cloud, may for example involve use of a symmetric key encryption scheme or a public key encryption scheme. Encryption may be performed by the media recording device such that a local copy can be stored in encrypted form and/or media is conveyed to the cloud in encrypted form. Alternatively, media may be conveyed in unencrypted form and then encrypted by a cloud service provider as it is being received and stored on the cloud or sometime after it has been received and stored on the cloud.

Various data access and user authentication methods can be employed to control access and/or deletion to data stored on the media recording device or on the cloud. Such methods may include a password, a signature, or a biometric such as an eye scan, a fingerprint scan, a facial image (i.e., individual's photo, a selfie), a recognized voice, or the like. At least one physical key (e.g., a dongle) may be required to access data, where multiple keys (or dongles) distributed to multiple persons may be required to access or delete data. A third party authentication service provider might be used such as VeriSign. Generally, one skilled in the art of protecting data stored on an electronic device or across a network will understand that all sorts of methods can be employed to control access to data and to authenticate a user, where such controls can also be used to prevent unauthorized data deletion. Moreover, rules can be employed in conjunction with such access control methods, for example, access and/or data deletion may be limited to a certain time period, require a certain aging of data (i.e., an elapsed period of time), require an event to have occurred (such as described below), require the media recording device to be in a certain location, etc. Generally, the concepts described below relating to user-defined events being used to determine the starting and stopping of recording of a media recording device and corresponding conveying of recorded media to the cloud or the uploading of previously recorded media data to the cloud can also be applied for controlling access to and deletion of media stored on the cloud or on the media recording device. Alternatively, it may be desirable that a media can be identified that cannot be deleted from the media recording device and/or from the cloud under any circumstance or without participation by a third party given control over such access/deletion such as an attorney, an editor of a publication, or some third party service.

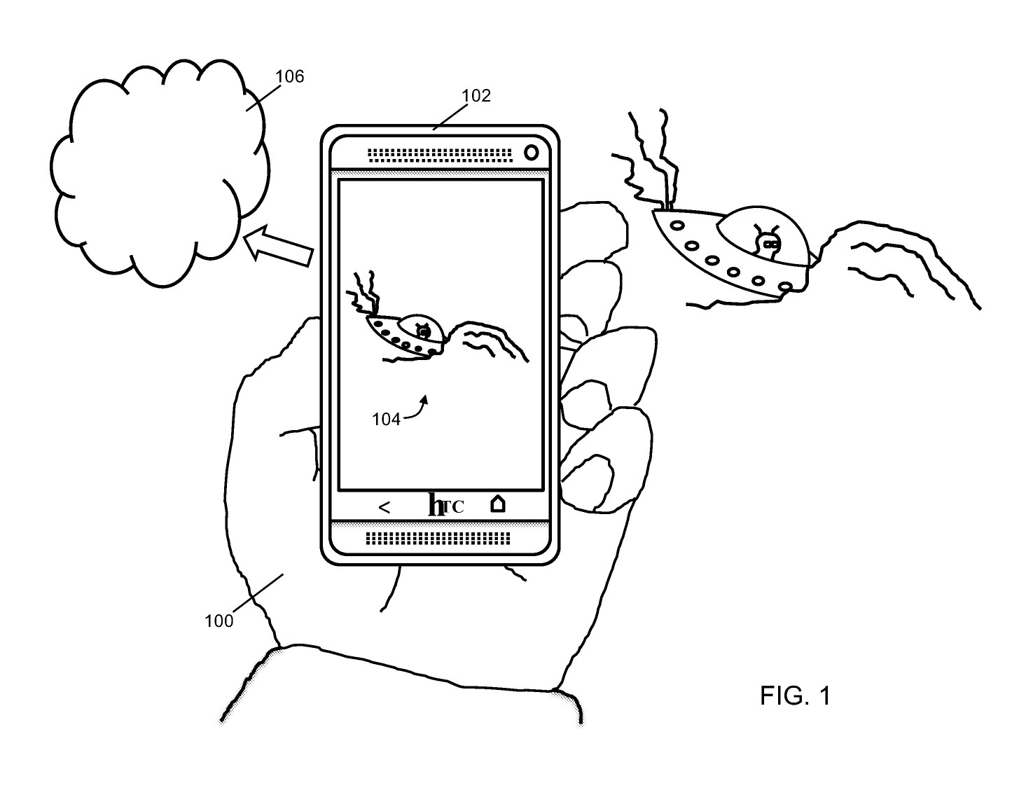

Under a first arrangement, which is depicted in FIG. 1, a user 100 of a media recording device 102 runs an application (or ‘app’) or otherwise selects a mode of operation of the media recording device 102 that causes a media 104 to be conveyed to the cloud 106 while the media 104 is being recorded by the media recording device 102 upon the occurrence of a user command. The media may be encrypted by the media recording device prior to the media being conveyed to the cloud. Alternatively, the media may be conveyed to cloud in unencrypted form where it then may or may not be encrypted. Under this arrangement, which may be referred to as a user-activated near real-time mode, storage of a local copy of the media on the media recording device is optional, where the media may be conveyed directly to the cloud and may never actually be stored locally on the media recording device. For example, a user of a mobile phone such as an HTC® phone may record an event with their phone and the media data would be conveyed directly to the cloud as it was being recorded with very low latency between the time a given data packet is recorded until it is stored on the cloud, where the data corresponding to the event would not be stored or otherwise be present on the phone unless it is necessary to temporarily buffer data for some required reason, for example, due to a poor or non-existent data connection between a first and second media recording device or between a media recording device and the cloud. Alternatively, the user may choose to store a local copy of the media data on the phone while also conveying the media data directly to the cloud as the media is being recorded, where the local copy of the media data may be encrypted or unencrypted and where the data conveyed to the cloud may be encrypted prior to being conveyed to the cloud or the data may be encrypted after it has been conveyed to the cloud. For example, unencrypted data might be conveyed to a cloud service provider that encrypts the data it receives from the media recording device prior to storing it, where the time required to encrypt the media would not add to the data latency of the media recording device, but the data would be vulnerable while be conveyed to the cloud because it is in an unencrypted form. Depending on the conditions of a given situation, it may be preferable to reduce data latency of the media recording device by not requiring the media recording device to encrypt a recorded media prior to conveying it to the cloud. As such, a user can establish rules used to control whether such processing is performed or not depending on the conditions of a given situation. For example, a user might set up a rule whereby video footage of a business security system would be automatically encrypted and conveyed to the cloud upon the occurrence of a user-defined security alarm event but encryption should not be performed should a fire condition (e.g., fire alarm, a sensor detecting smoke or heat, etc.) also be detected. Generally, all sorts of rules can be employed to control the processing performed prior to conveyance of media data to the cloud based on one or more conditions so as to control data latency.

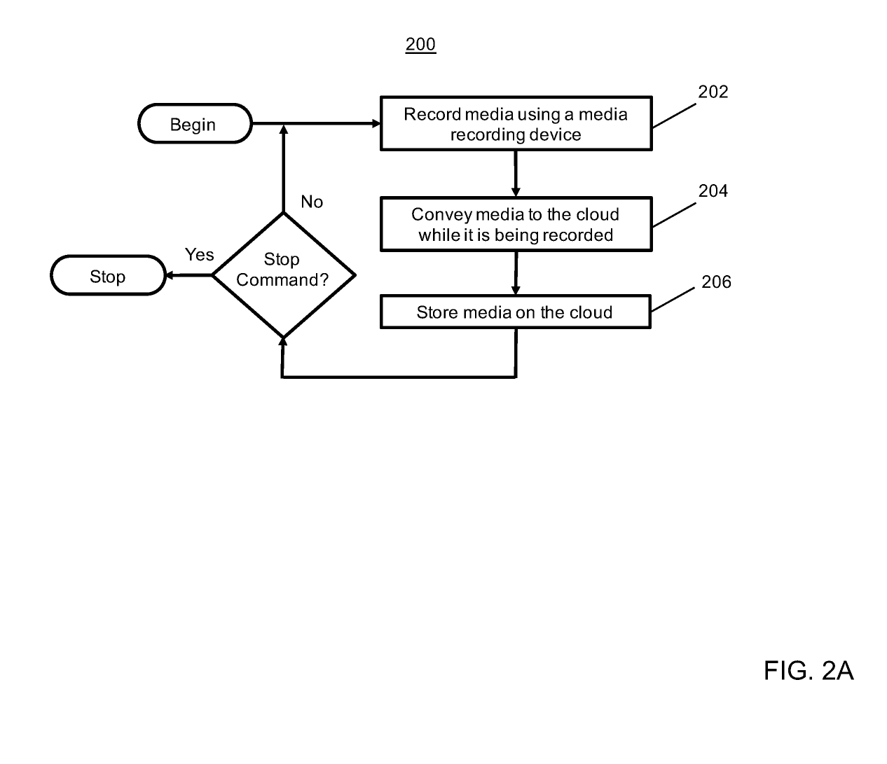

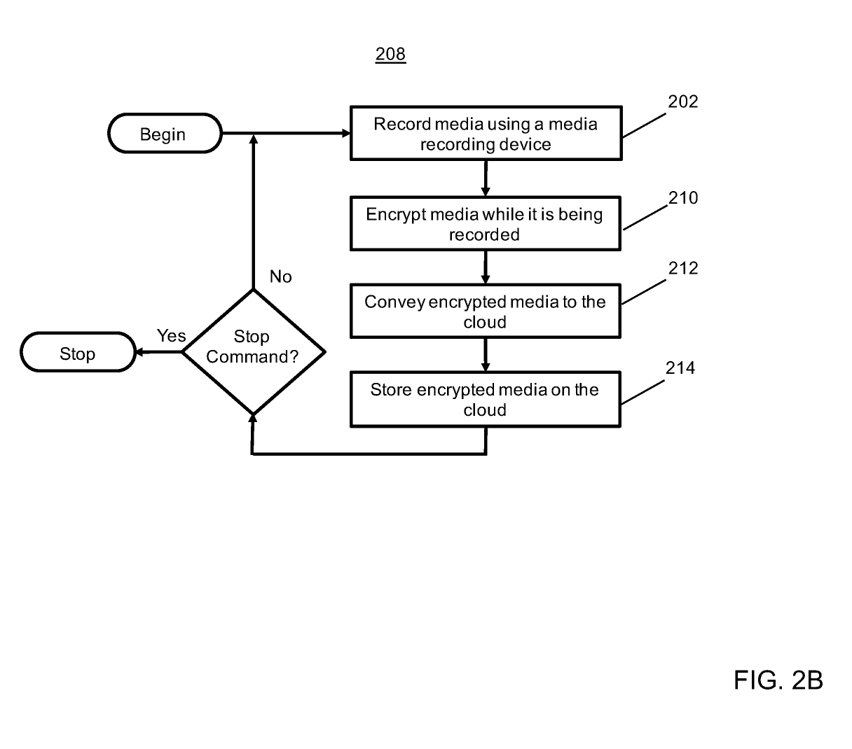

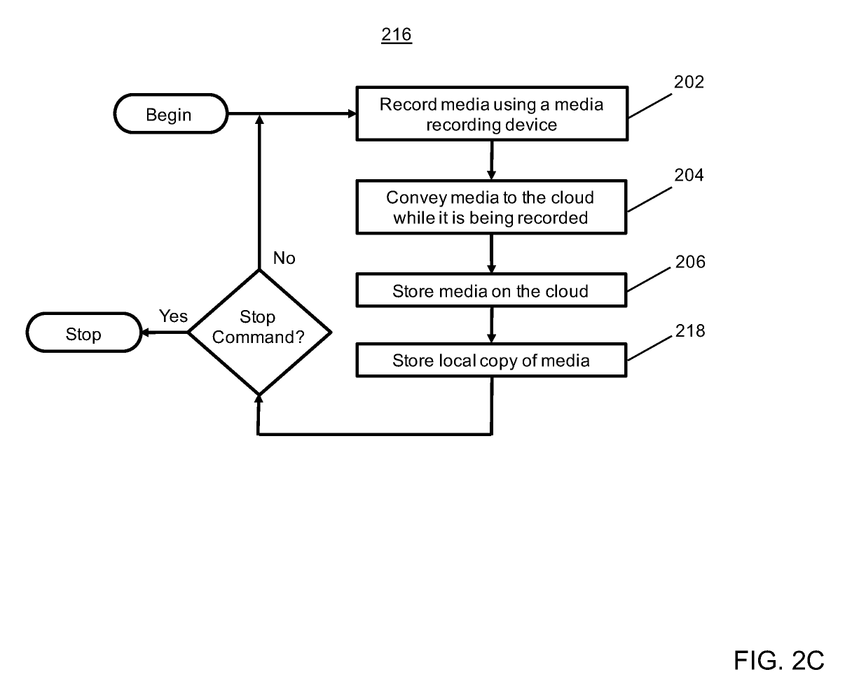

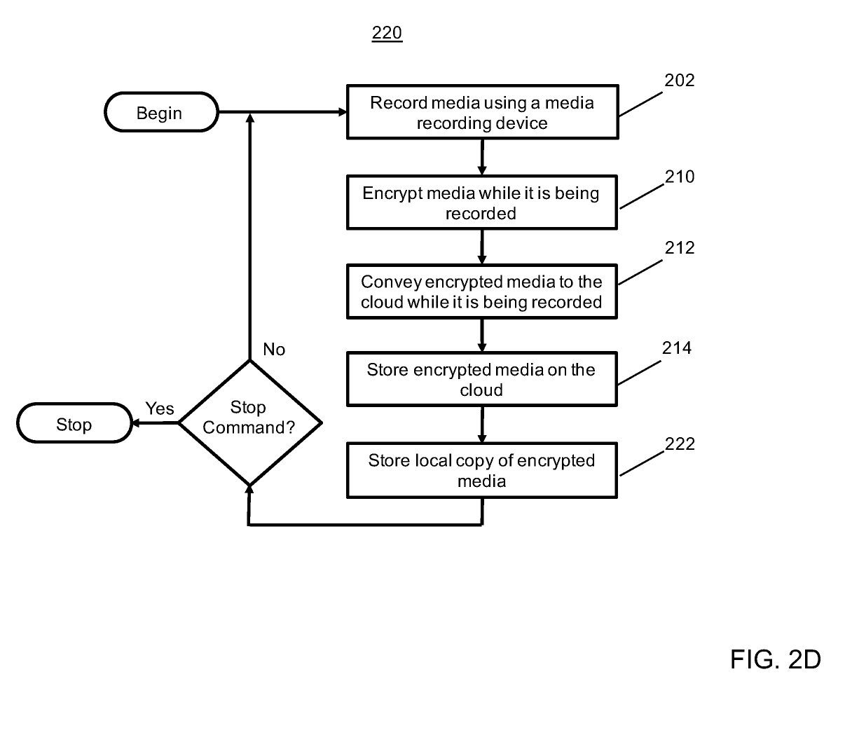

FIGS. 2A-2D depict exemplary methods corresponding to a user-activated near real-time mode, where the amount of data latency between the time a given data packet is recorded until it is stored on the cloud depends on whether or not media is encrypted and whether or not a local copy of the media (or encrypted media) is stored on the media recording device. In reference to FIG. 2A, one skilled in the art will recognize that once media has been received by the cloud it may be recorded by a cloud service provider prior to storage or at any time thereafter.

Under a second arrangement, a media recording device is configured to automatically begin and/or stop recording media to be encrypted and conveyed to the cloud while the media is being recorded by a media recording device upon the occurrence of a defined event or events. Under this arrangement, which may be referred to as an event-activated near real-time mode, storage of a local copy of the media on the media recording device is optional, where the local copy of the media data may be encrypted or unencrypted while stored on the media recording device.

An event can be generally described as an occurrence that meets an established criterion, condition or rule that can be recognized by a control system (e.g., an application running on a cell phone). For example, an event may be based on a position of an object/person/animal/vehicle, for example, a cell phone's specific location (i.e., latitude, longitude) as might be determined by a location system such as a global positioning system (GPS). An event might correspond to a status of a media recording device, for example, a battery status or a signal strength status. Similarly, an event might be based on a position of an object relative to a location of another object, where both objects might be fixed or mobile. Such location based events are commonly known as geolocation events where, generally, an event can be defined based on the location of one or more objects relative to one or more defined areas (e.g., a perimeter or a property or a building, or a room within a building) corresponding to one or more locations. An event may be based on movement, lack of movement, or a change in movement (e.g., speed or direction) of an object, which might be detected using a compass. For example, an ‘impact threshold’ may be established corresponding to an abrupt movement change indicating an impact associated with a media recording device (e.g., hitting the ground, being in a vehicle crash, etc.).

An event may be based on a position, for example, a position of the phone within a coordinate system. An event may relate to a movement of the phone or the non-movement of the phone, which might be detected using an accelerometer. An event may relate to a detected movement, which might be detected by a motion or proximity detector/radar. An event may be based on an orientation of an object, which might be measured using a 6-DOF measurement device. In one arrangement, the orientation of a phone may be determined using a magnetometer contained in a media recording device.

An event may be based upon an emergency or alarm situation, which might involve a severe weather advisory or warning relating to a thunderstorm, tornado, hurricane, snowstorm, high wind, etc. or any other sort of emergency situation such as a vehicle accident or crash, a break-in, a fire, a flood, a landslide, a prisoner escape, a riot, a hazardous materials spill, a runaway train, an airplane experiencing an emergency situation, etc. For example, a media recording device may be set to automatically begin recording if a nearby nuclear reactor alarm were to sound or if a person presses a medical alert button.

An event might involve a government controlled security level, for example, a Transportation Security Administration (TSA) security level, Home Security level, or DEFCON level.

An event might be a sensed environmental condition such as a sensed temperature, humidity, light, smoke, carbon dioxide, seismic event, sound intensity and/or frequency, pressure, altitude, water depth, or the like, which might be measured using one or more sensors. For example, a sensor might detect an earthquake, an explosion, thunder, a gunshot, or a scream. Similarly, an event might be a sensed physical condition of a person or animal such as a heart rate, breathing rate, skin resistivity, blood pressure, body temperature, blood sugar level, etc. One skilled in the art will also recognize that if the media recording device is configured to received sensed information then the media recording device can also perform various other processing beyond uploading media to the cloud relating to the sensed information. For example, seismic information sensed by the media recording device might be used to identify the location, timing, and magnitude of a seismic event, which might even be used to determine an amount of time before a catastrophic even will occur at the location of the recording media device for providing warning, instructions, or other relevant information.

An event may involve the recognition of a command such as a voice command, a hand gesture, or a RF signal command.

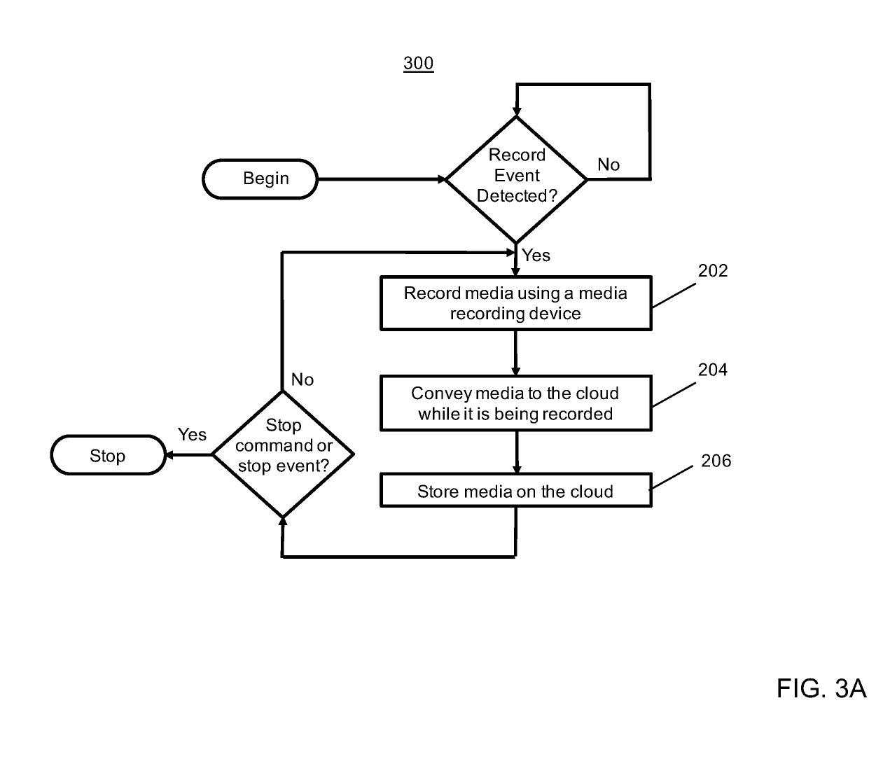

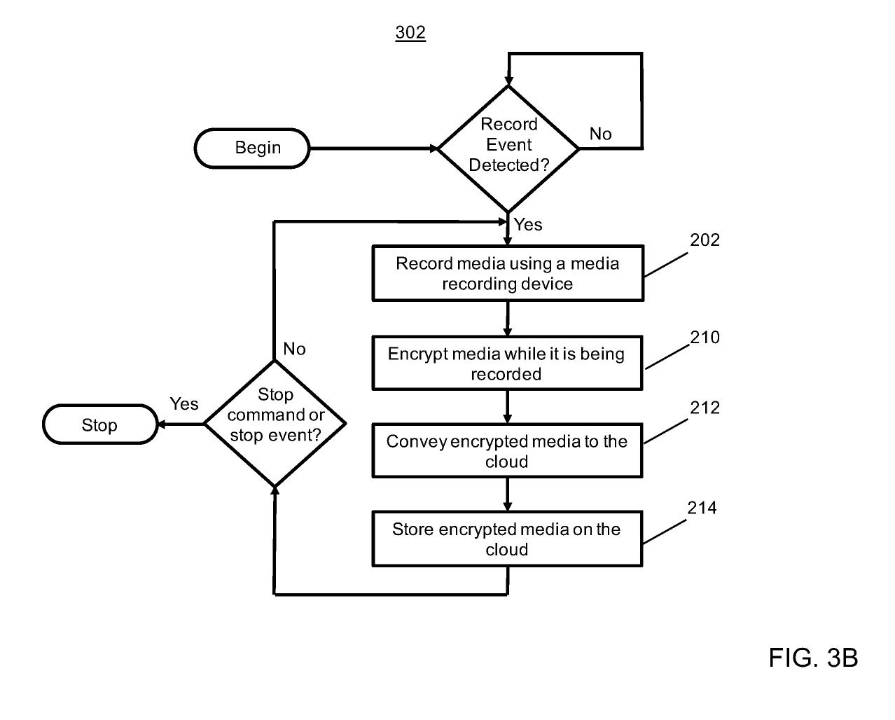

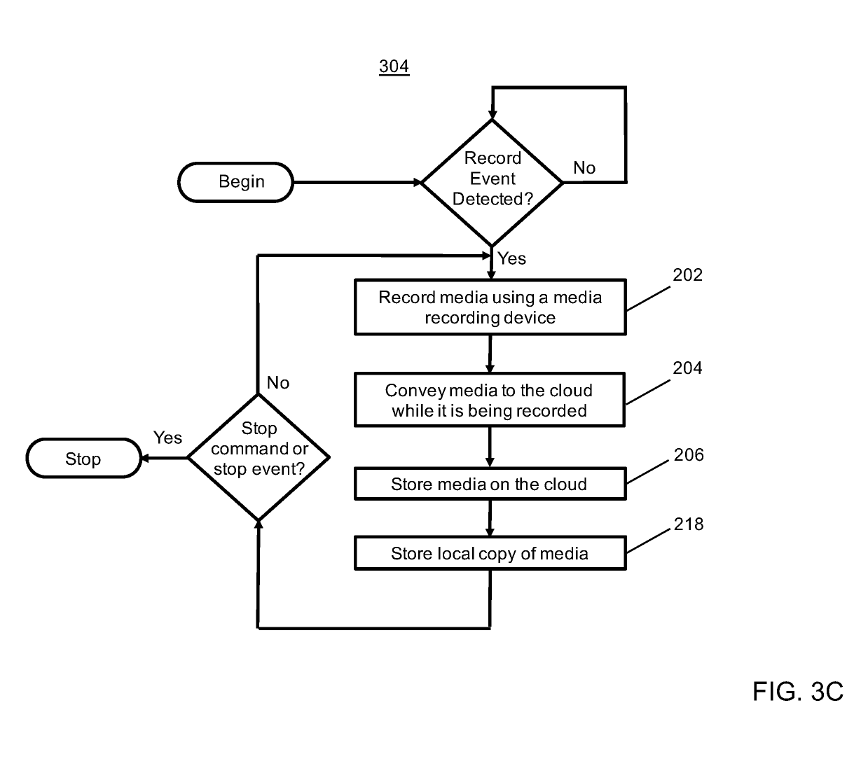

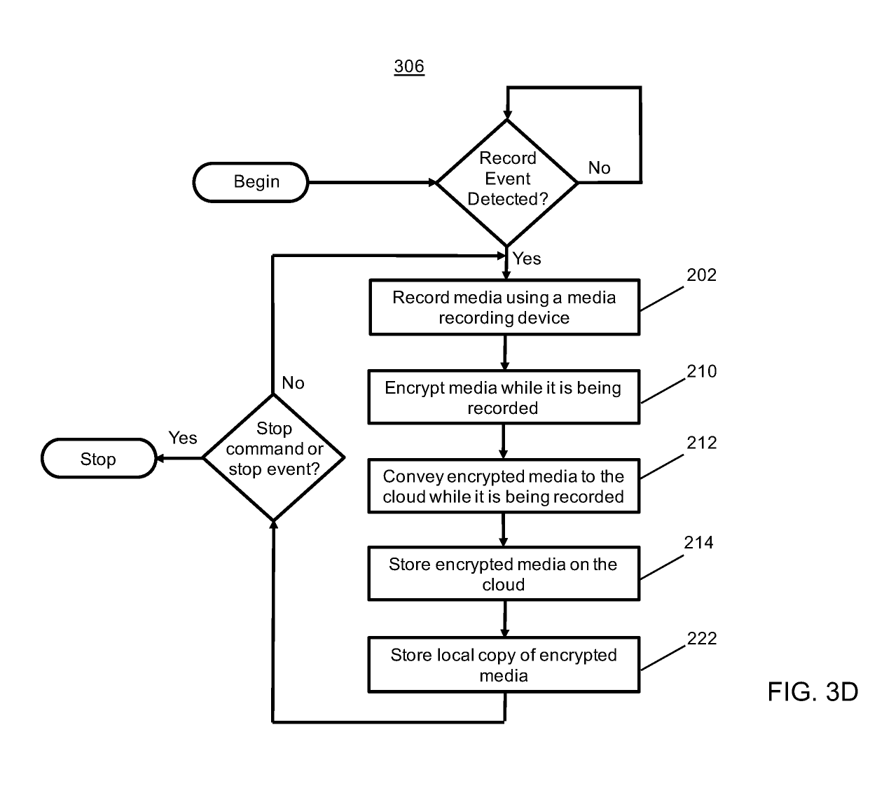

FIGS. 3A-3D depict exemplary methods corresponding to an event-activated near real-time mode, where the amount of data latency between the time a given data packet is recorded until it is stored on the cloud depends on whether or not media is encrypted and whether or not a local copy of the media (or encrypted media) is stored on the media recording device. In reference to FIG. 3A, one skilled in the art will recognize that once media has been received by the cloud it may be recorded by a cloud service provider prior to storage or at any time thereafter.

Under the first or second arrangements, efforts can be made to limit latency between recording and conveyance to the cloud to an amount less than or equal to a defined latency limit, where to meet an established latency limit, storing of a local copy of the media and/or encryption of the local copy may not occur.

Under a third arrangement, a local copy of a recorded media is stored on the media recording device and all or part of the stored local copy of the media is encrypted and conveyed to the cloud in accordance with a defined schedule. The scheduled uploading of the media to the cloud may be referred to as a scheduled upload mode, where the local copy of the media data may be encrypted or unencrypted while stored on the media recording device. Optionally, the media data can be automatically deleted from the media recording device once it has been conveyed to the cloud. For example, a user of a phone may choose to have media data moved from a phone to the cloud weekly, daily, hourly, or at specific scheduled times and/or in response to an event, for example, a voice command, a location, an emergency condition, etc. The media may be stored and uploaded using a rolling period of time, for example, at the end of each day, the stored media data from the same day one week prior may be automatically deleted such that, at any given time, there is stored media data for the most recent seven days, where the rolling periodic upload mode can be overridden, the rolling period of time can be changed (increased or decreased), and specific subsets of stored media data can be identified as not to be deleted. For example, a rolling period of time mode might be configured to only delete media data from 12 pm to 6 am or to never delete data recorded on a Saturday. Generally, one skilled in the art will recognize that all sorts of options for controlling one or more periods of time where stored media data would be uploaded to the cloud and automatically deleted from local storage, or not, are possible.

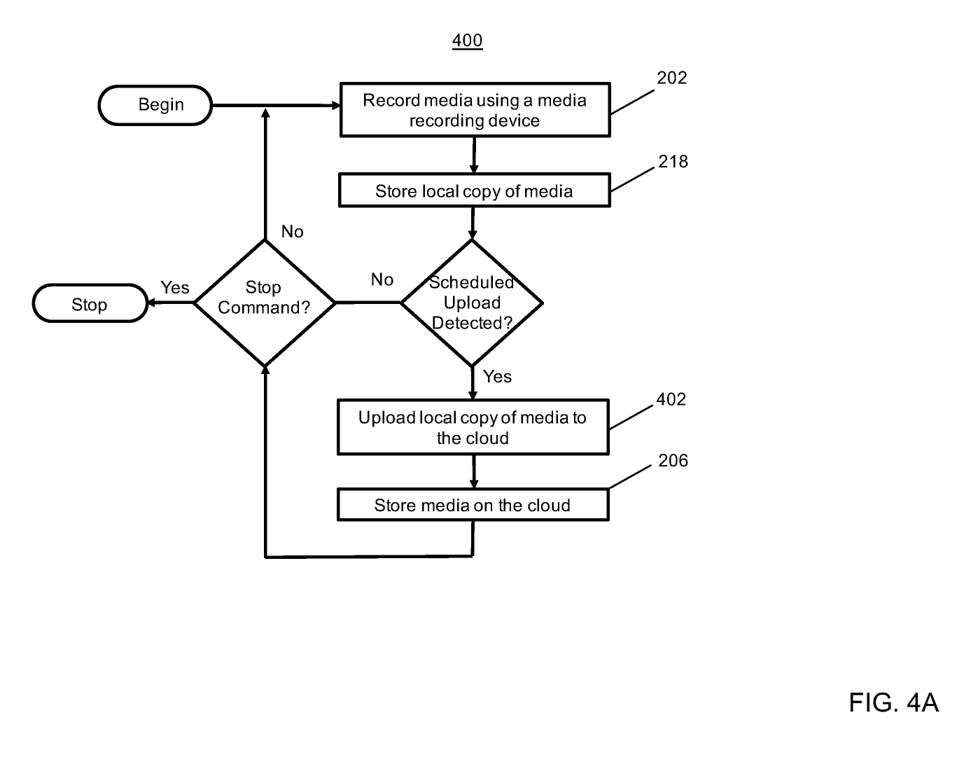

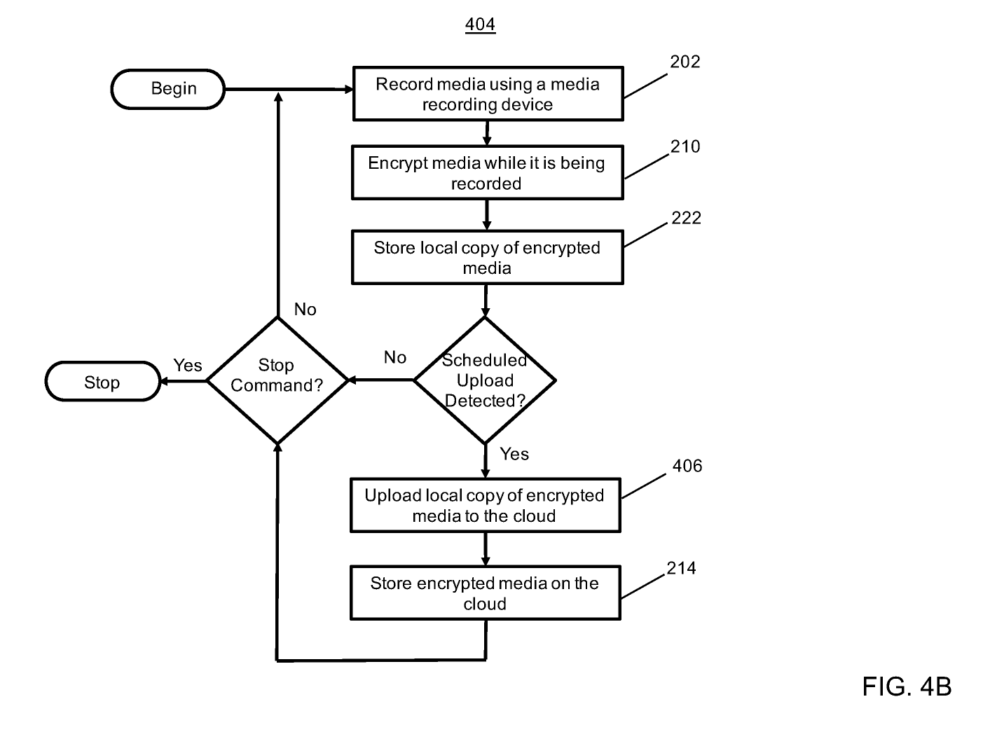

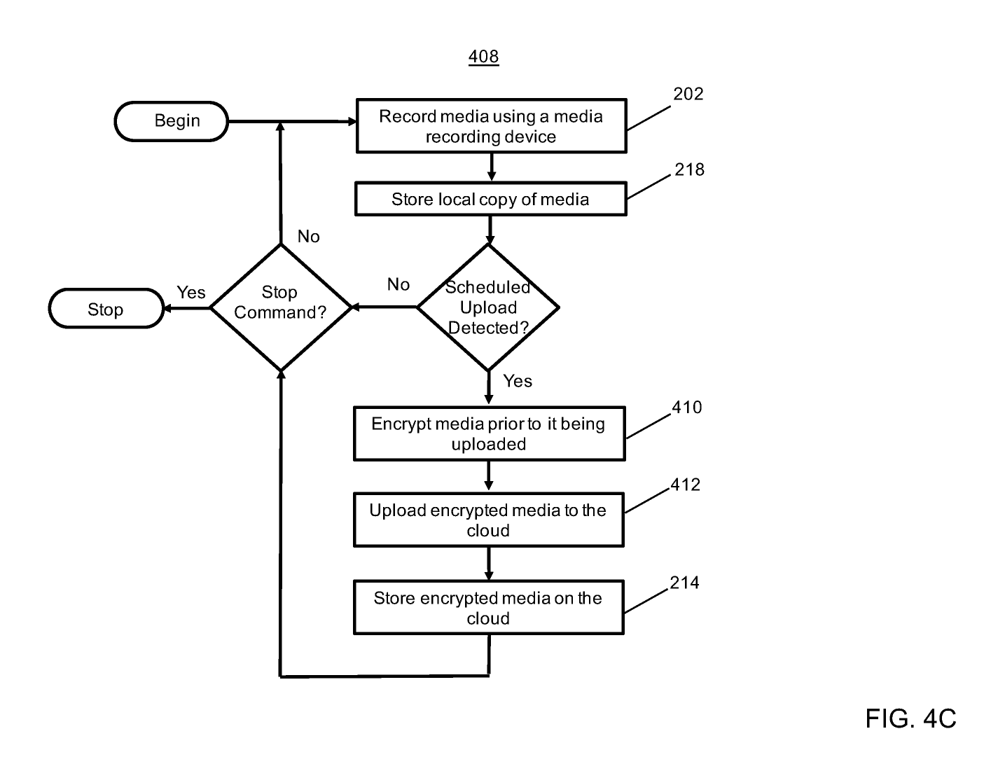

FIGS. 4A-4C depict exemplary methods corresponding to a scheduled update mode, where the amount of data latency between the time uploading of a stored media begins until it is stored on the cloud depends on whether or not the media is encrypted by the media recording device. In reference to FIG. 4A, one skilled in the art will recognize that once media has been received by the cloud it may be recorded by a cloud service provider prior to storage or at any time thereafter.

Under a fourth arrangement, a local copy of a recorded media is stored on a media recording device and then later automatically conveyed to a cloud computing environment upon the occurrence of an event, such as described above, where the media may be encrypted prior to being conveyed to the cloud and where the local copy of the media data may be encrypted or unencrypted while stored on the media recording device. Optionally, the media data can be automatically deleted from the media recording device once it has been conveyed to the cloud.

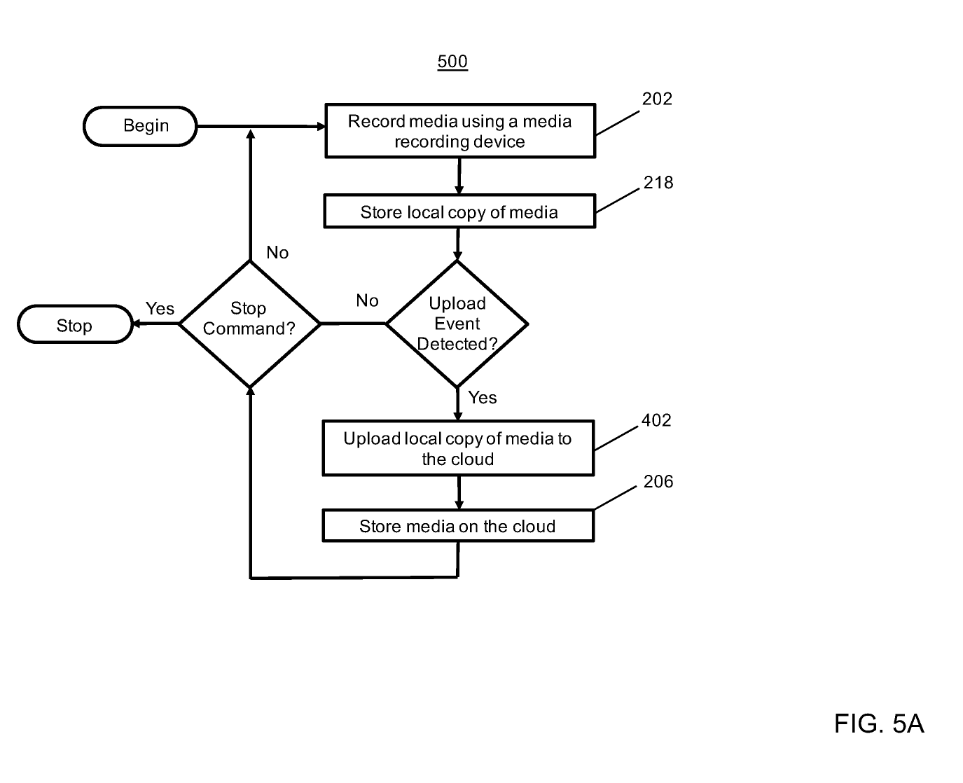

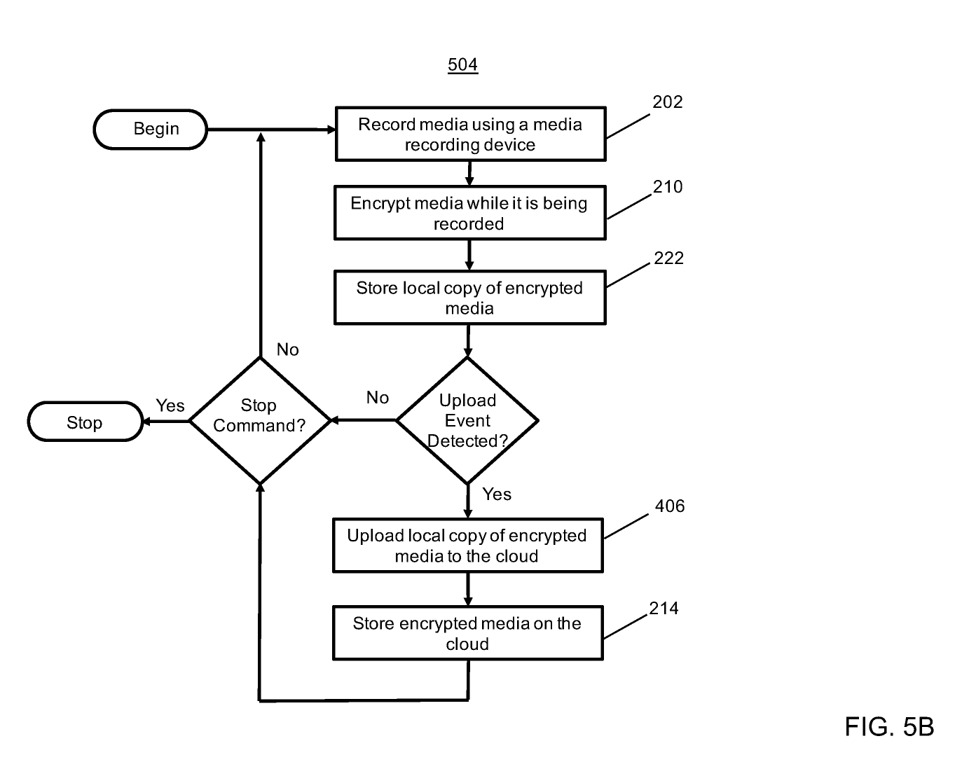

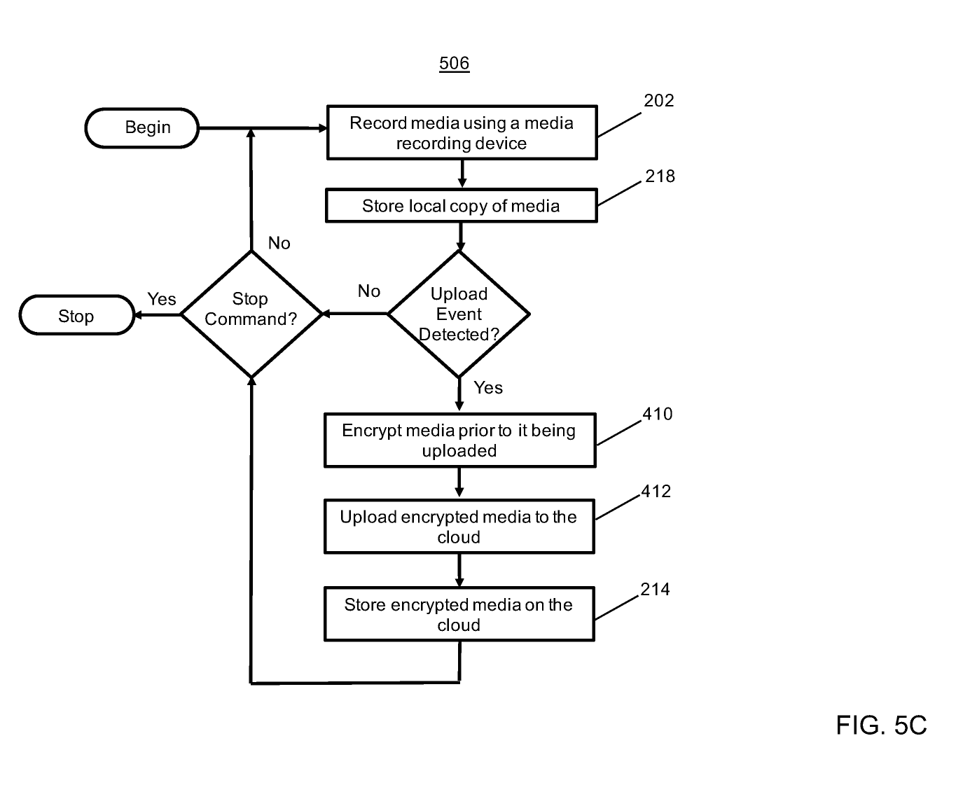

FIGS. 5A-5C depict exemplary methods corresponding to an event-activated update mode, where the amount of data latency between the time uploading of a stored media begins until it is stored on the cloud depends on whether or not the media is encrypted by the media recording device. In reference to FIG. 5A, one skilled in the art will recognize that once media has been received by the cloud it may be encrypted by a cloud service provider prior to storage or at any time thereafter.

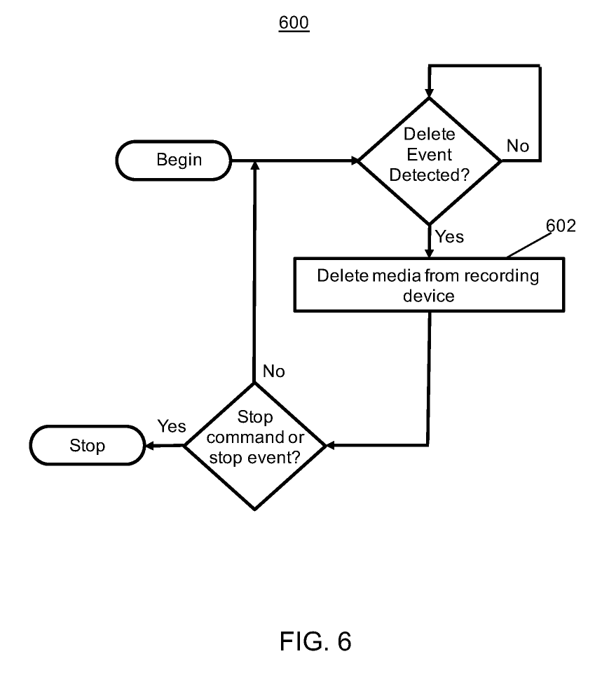

Under a fifth arrangement, a local copy of a recorded media is deleted upon the occurrence of an event, such as described above. FIG. 6 depicts an exemplary method corresponding to an event-activated delete mode.

Various metadata can be conveyed to the cloud along with the media data such as the media author, media title, date and time of the media recording, location and/or orientation of the media recording device, velocity, acceleration, temperature, barometric pressure, biometric data, light levels, etc. Metadata might include the person or persons in a video, or a short description or keyword(s) such as wedding, pet's name, flowers, waterfall, food, or the like. Generally, one skilled in the art will understand that such metadata can be used to enable processing of the media data from the cloud to include a user retrieving a subset or subsets of such media data based upon a query of the metadata stored along with the media data. Whether or not metadata is added to media prior to it being conveyed to the cloud can also be controlled in accordance with a data latency limit in a manner similar to how encryption can be controlled. Similarly, whether or not metadata is added to media prior to it being conveyed to the cloud can also be controlled in accordance with an established rule and one or more conditions of a situation. Under one arrangement, metadata (e.g., timing and location) corresponding to one or more records corresponding to one or more recorded media of one or more recorded media devices may be used to located the source of a sound as recorded by the one or more media recording devices, where one skilled in the art will recognize that one recorded sound might provide a range of the source relative to a recording device, two recordings of the sound may determine a plane relative to the locations of the recording devices, and three recordings of the sound may identify a coordinate of the source relative to the three recording devices. A source of a sound could be, for example, a gun or a tornado. One skilled in the art will recognize that all sorts of data processing involving multiple recorded media data by one or more media recording devices are possible.

A user interface could be used to define the events, rules, and conditions required to support event-activated approaches described herein. Similarly, a user interface can be used to define limits such as latency limits, to manage encryption, and to enter metadata. Similarly, a user interface can be used to produce queries used to retrieve media data from the cloud. Generally, one skilled in the art of data management will understand that such interfaces can be employed to practice the invention.

The following are examples of the use of the present invention:
a baby monitoring system whereby a sensed condition such as a temperature, irregular heartbeat, or the like cause the baby monitoring system to convey sound, video, and sensor information to the cloud, where it may then be forwarded to medical personnel either manually or automatically as part of a service.
a business security system whereby a detected forced entry automatically conveys security footage to the cloud, where it may then be forwarded to security personnel or police either manually or automatically as part of a service.
a structure health monitoring system whereby upon the occurrence of an earthquake sensor information pertaining to the health of the structure (e.g., bridge, building, dam, etc.) is automatically conveyed to the cloud where video footage may also be automatically recorded and conveyed.
a personal video monitoring system worn on a person automatically beginning recording and conveying video and/or sensor information to the cloud upon recognition of an irregular heartbeat or other sensed characteristic of a person, which might result from fear, an accident, a medical condition (e.g., a diabetic seizure), excitement, or the like.
a vehicle monitoring system that begins recording occurrences outside the vehicle and/or inside the vehicle given a sensed condition such as a break-in of the vehicle, the vehicle being in an accident, the vehicle being driven recklessly, etc.
a drone-based video surveillance system reacts to an occurrence on the ground (e.g., a detected explosion) by directing the drone to reduce altitude or alter course so as to achieve a different surveillance location or to cause a zoom function in a camera to zoom in so as to better view the occurrence on the ground.

The present invention can be practiced using publicly available computing devices, communications networks, and related software or can be practiced using proprietary computing devices, communications networks, and/or software. Rules and thresholds and the like can be established for one or more media recording devices using one or more computing device (e.g., a desktop computer) other than a recording device. Similarly, an interface can be provided to access media data stored on the cloud via computing devices other than a media recording device. Under one arrangement, a product is provided that includes a software application resident on a media recording device and a software application resident on a computing device other than a recording device. For example, an application running on a cell phone may store media data to the cloud that is later accessed via a desktop computer via an internet connection. Similarly, an application (e.g., a dashboard) executing on a desktop computer may be used to configure parameters (e.g., rules, thresholds, etc.) relating to a user account that are then loaded by a cell phone application and used to manage the conveyance of recorded media data to the cloud by the cell phone. Under another arrangement, one or more other applications used to manage events such as a calendar management application (e.g., Microsoft Outlook®) can be used to establish and manage events that are used to manage the conveyance of media data to the cloud. For example, a meeting request received via an email may establish a location and a time used in a rule used to manage the conveyance of media data to the cloud. Similarly, an alert condition established in a weather alert application might be inherited by another application managing the conveyance of media data to the cloud. Under yet another arrangement, the application managing the conveyance of media data to the cloud may interface with one or more publicly available data sources (e.g., National Weather Service, USGS Earthquake Early Warning system, a RSS news blog) and/or private data sources (e.g., a Social Directory API), where data provided by the one or more publicly available data sources and/or private data sources may be used, for example, to determine the occurrence of an event.

The present invention may be used as part of a monitoring service where the control of media recording functions can be at least partially managed by the monitoring service. For example, one or more media recording devices within a home or business may be activated based on a detected condition, a schedule, or as part of a random status check, where certain parameters are controllable by a user (e.g., home owner, business owner).

The present invention may take advantage of artificial intelligence algorithms that enable a media recording device to establish its own rules make its own decisions regarding which functions should be employed and to what extent as determined based on one or more events.

Under one arrangement, a media recording device may be configured to operate without displaying images being recorded on the display of the device. For example, a phone may be filming and streaming a video to the cloud without displaying the video on the display of the phone. This ‘non-display recording mode’ might be activated by a user selecting a button, providing a voice command, or automatically due to the occurrence of an event (e.g., a detected abrupt movement), etc. in the same manner as media recording can be activated.

In accordance with an embodiment of the invention, multiple media recording devices may be configured to collaborate. In one arrangement, data samples from different devices can have relative timings that are coordinated. For example, if three media recording devices are recording the same event from three different locations the their data samples may have staggered timing such that the timing of data samples from the first media recording device may be provided every 3 seconds beginning at time t₀, data samples from the second media recording device may be provided every 3 seconds beginning at time t₀+1 second, and data samples from the third media recording device may be provided every 3 seconds beginning at time t₀+2 second. Alternatively, two or more media recording devices may coordinate their times such that they take data samples at substantially the same times, t₀, t₁, t₂, etc. Other forms of collaboration include: 1) sharing of rules, thresholds, sensor information, and the like such that a set of parameters can be established that is used to manage conveyance of media data produced by multiple media recording devices, 2) sharing of recorded data among media recording devices allowing the display of information from multiple devices as an event is being recorded by the devices, 3) sharing of warnings and messages between devices upon occurrences of events (e.g., Fred's phone is code red and located at x,y,z coordinates).

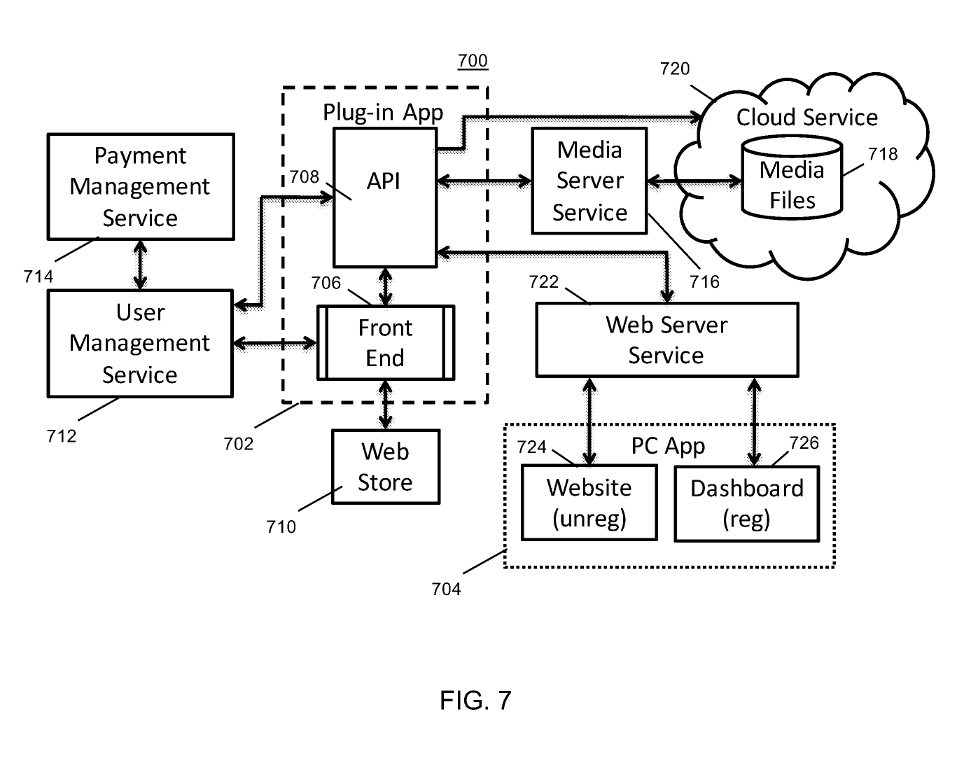

FIG. 7 depicts an exemplary computing architecture 700 in accordance with the invention. Referring to FIG. 7, the computing architecture 700 includes a plug-in application 702 (e.g., a cell phone ‘app’) and a PC application 704. The plug-in application 702 includes a front end 706 and an application program interface (API) 708. The front end 706 provides a user interface that enables a user to log into the application which would involve use of a user management service 712, which provides user login and authentication capabilities, and corresponding payment management service 714, which provides for various means of payment for the application's services, products, etc. The user management service 712 provides notification to the API 708 that the user is authorized (i.e., authenticated and appropriates payments have been made) to use the application. The API 708 interfaces with a cloud service 720 and interfaces with a media server service 716 which streams media data to one or more media file databases 718 provided by the cloud service 720. The API 708 also interfaces with a web server service 722, which interfaces with a website 724 and a dashboard 726. The website 724 provides unregistered users a product description, pricing, and a product registration form. Once registered, a user is able to access the dashboard 726 that can be used to configure parameters relating to the user's account and provides access to the user's media files.

While particular embodiments of the invention have been described, it will be understood, however, that the invention is not limited thereto, since modifications may be made by those skilled in the art, particularly in light of the foregoing teachings.

1. A method for conveying media to a cloud computing environment, comprising:
enabling a user of a media recording device to establish a data latency rule;
recording a media using said media recording device to produce media data, said media recording device controlling a data processing function pertaining to said media data in accordance with said data latency rule; and
conveying the media data to a cloud computing environment.

2. The method of claim 1, wherein said data latency rule pertains to a data latency threshold.

3. The method of claim 1, wherein said data latency rule pertains to a user defined condition.

4. The method of claim 1, wherein said data latency rule pertains to a sensed condition.

5. The method of claim 1, wherein controlling said data processing function controls whether said processing function is performed.

6. The method of claim 5, wherein said data processing function involves encrypting said media data.

7. The method of claim 5, wherein said data processing function involves storing said media data on said media recording device.

8. The method of claim 5, wherein said data processing function involves including metadata with said media data.

9. The method of claim 8, wherein said metadata comprises one of an identity of the media author, a media title, a date of the media recording, a time of the media recording, or a location where the media was recorded.

10. The method of claim 8, wherein said metadata comprises a characteristic of the media recording device.

11. The method of claim 10, wherein said characteristics comprises one of an orientation of the media recording device, a velocity of the media recording device, an acceleration of the media recording device, or a geolocation of the media recording device.

12. The method of claim 8, wherein said metadata comprises a characteristic of the physical environment in which the media recording device was located when said media was recorded.

13. The method of claim 12, wherein said characteristic is one of a temperature, a barometric pressure, or a light level.

14. The method of claim 8, wherein said metadata comprises biometric data.

15. The method of claim 1, wherein controlling said data processing function controls an amount or rate corresponding to said data processing function.

16. The method of claim 15, wherein said amount or rate pertains to at least one of data sampling, data compression, data buffering, or data resolution.

17. The method of claim 1, wherein said media recording device is a mobile phone.

18. The method of claim 1, wherein said media recording device is located in a building.

19. The method of claim 1, wherein said media recording device is located on one of a person or an animal.

20. The method of claim 1, wherein said media recording device is associated with a vehicle.
